(19) United States
(12) Patent Application Publication
(10) Pub. No.: US 2009/0017852 A1
(43) Pub. Date: Jan. 15, 2009

(54) TRANSMITTER, MODULATOR AND METHOD FOR SIGNAL SYNCHRONIZATION TRANSMISSION IN SINGLE FREQUENCY NETWORK TRANSMISSION SYSTEM

(75) Inventors: Hui ZHANG, Beijing (CN); Jiongliang LI, Beijing (CN); Fei MENG, Beijing (CN)

Correspondence Address: SCULLY SCOTT MURPHY & PRESSER, PC, 400 GARDEN CITY PLAZA, SUITE 300, GARDEN CITY, NY, 11530, US

(73) Assignee: INNOFIDEI INC., Beijing (CN)

(21) Appl. No.: 12/171,673

(22) Filed: Jul. 11, 2008

(30) Foreign Application Priority Data
Jul. 13, 2007 (CN) 200710118789.0

(51) Int. Cl. H04B 7/005

(52) U.S. Cl. 455/502

(57) ABSTRACT

A method, transmitter and modulator for signal synchronization transmission in a single frequency network transmission system are disclosed. The method includes: extracting effective data from data received; performing channel coding, mapping and modulation to the effective data extracted and saving the data modulated into storage; and retrieving the data from the storage upon receiving a pulse indication signal, performing digital-to-analog conversion and baseband-to-radio frequency conversion to the data retrieved and transmitting the data converted into air via antennae. The technical scheme enables different transmitters to transmit signals synchronously.

### FIELD OF THE INVENTION

The present invention relates to a Single Frequency Network (SFN) system, and particularly, to a transmitter, modulator and method for signal synchronization transmission in a SFN transmission system.

### BACKGROUND OF THE INVENTION

A variety of techniques are currently adopted to increase the spectrum utilization efficiency. A Single Frequency Network (SFN) technique is a key technique that is quite effective. A SFN system consists of multiple digital transmitters and covers a large area with reticulate distribution of transmission stations. A typical SFN system in the prior art mainly includes a center station, transmission stations and a distributive network. The center station includes a multiplexing module and an SFN adaptor and is adapted to distribute and concentrate signals. A transmission station, as a very important component of the SFN, includes a Global Positioning System (GPS) clock used for synchronization and a modulator. A center station usually corresponds to a plurality of transmission stations, e.g., several or tens of (or even more) transmission stations according to the size of the SFN. The distributive network, also called a program allocation system, may include links of microwave, optical fiber, communication cable and satellites and is adapted to distribute the signals from the center station to the transmission stations.

In the SFN system, the transmitters at different locations need to transmit signals from a same program source synchronously at a same frequency and with symbols of the same alignment. Synchronization, common frequency and common source are the three basic requirements to SFN transmission, and synchronization is most important. If different transmitters can not transmit signals synchronously, undesired multi-path channel effect is created, and the performance of receivers is largely reduced. To ensure different transmitters to transmit data at exactly the same time, clock signals, such as 10 MHz signals, and pulse indication signals, such as PP1S signals (or PPxS signals, wherein x is an integer larger than or equal to 1), from a public synchronization indication system such as a GPS are usually needed. According to the clock signals and pulse indication signals from the GPS, all transmitters work at the same clock frequency and transmit data upon receiving a pulse indication signal. The synchronization transmission is realized.

### SUMMARY OF THE INVENTION

The embodiments of the present invention disclose a transmitter, a modulator and a method for signal synchronization transmission in an SFN transmission system so that transmitters with different baseband process modules can transmit data into air synchronously.

An embodiment of the present invention discloses a method for signal synchronization transmission in an SFN transmission system. The method includes:

A) extracting effective data from data received;

B) performing channel coding, mapping and modulation to the effective data extracted and saving the data modulated into a storage; and

C) retrieving the data from the storage upon receiving a pulse indication signal, performing digital-to-analog conversion and baseband-to-radio frequency conversion to the data retrieved and transmitting the data converted into air via antennae.

An embodiment of the present invention further discloses a modulator in a transmitter in an SFN. The modulator includes:

a channel coding module, adapted to receive the effective data extracted and performing channel coding;

a mapping module, adapted to receive the data coded by the channel coding and to map the data;

a modulation module, adapted to modulate the data mapped;

a digital-to-analog converter (DAC), adapted to convert the data modulated into analog signals; and

baseband-to-radio frequency converter, adapted to convert the analog signals into radio frequency signals to be transmitted into air via antennae;

the transmitter further including:

storage, connected to the modulation module and adapted to save the data modulated; and wherein

the modulator retrieves the data in the storage upon receiving a pulse indication signal and sends the data to the DAC.

An embodiment of the present invention further discloses a transmitter in an SFN. The transmitter includes a synchronization system and a modulation; in which

the synchronization system includes:

a effective data extraction module, adapted to receive data from the distributive network and extract effective data from the data; and

a pulse signal generation module, adapted to provide a pulse indication signal which includes at least a first pulse indication signal;

the modulator includes:

a channel coding module, adapted to receive the effective data extracted and performing channel coding;

a mapping module, adapted to receive the data coded by the channel coding and to map the data;

a modulation module, adapted to modulate the data mapped;

a DAC, adapted to convert the data modulated into analog signals; and

a baseband-to-radio frequency converter, adapted to convert the analog signals into radio frequency signals to be transmitted into air via antennae;

and the modulator further includes a storage, which further includes at least

a first storage, connected to the modulation module and adapted to save the data modulated; and wherein

the modulator retrieves the data in the first storage upon receiving the first pulse indication signal and sends the data to the DAC.

According to the technical solution disclosed by the embodiments of the present invention, the data is saved temporally in the storage before being processed by the DAC. The radio frequency synchronization transmission point is set at a processing point between the storage to the DAC. The time consumption of different DACs or of different baseband-to-radio frequency converters are almost the same, if the data is retrieved by the transmitters and sent to the DAC upon receiving the pulse indication signal, the data will be transmitted into air at the same time and the signal synchronization transmission among multiple transmitters is achieved.

An optimized technical scheme according to an embodiment of the present invention discloses that the data is saved temporally in a step before modulation and retrieved by the transmitters at the same time according to a pulse indication signal for further processing. In other words, the baseband synchronization transmission point is set in a step before the modulation to synchronize the data first to reduce the pressure for saving data temporally at the radio frequency synchronization transmission point.

### BRIEF DESCRIPTION OF THE DRAWINGS

FIG. 1 is a schematic diagram illustrating a network architecture of a DVB system.

FIG. 2 is a flow chart of a method for signal synchronization transmission in an SFN transmission system according to an embodiment of the present invention.

FIG. 3 is a block diagram illustrating a modulator in a transmitter in an SFN transmission system according to an embodiment of the present invention.

FIG. 4 is a block diagram illustrating a transmitter in an SFN transmission system according to an embodiment of the present invention.

FIG. 5 is a block diagram illustrating a transmitter according to an embodiment of the present invention.

FIG. 6 is a block diagram illustrating a modulator according to an embodiment of the present invention.

### DETAILED DESCRIPTION OF THE INVENTION

In a conventional SFN synchronization transmission schemes, such as a Digital Video Broadcast (DVB) scheme, with reference to FIG. 1, a transmitter extracts data from a synchronization (SYNC) system module upon receiving a pulse indication signal and sends the data to a DVB-T modulator, the data stream is aired as radio frequency signals after being processed by the DVB-T modulator. In other words, in the DVB scheme of synchronization transmission, the synchronization transmission point is at a processing point of the baseband processing procedure.

All transmitters in the SFN are required to transmit signals at exactly the same time, and if the synchronization transmission point is at a processing point of the baseband processing procedure, all transmitters need to have exactly the same time consumption in all steps between synchronization transmission point and the actual transmission to ensure that the data are aired synchronously. In practical applications, the baseband process modules from different transmitter manufacturers may adopt different technology, which makes the time consumption different in the steps. To ensure the time consumption in all steps to be exactly the same, the system has to use transmitters from one manufacturer or from a limited number of manufacturers. This disturbs the operation of networks, hinders the healthy growth of the market and limits the development of SFN systems.

The technical scheme of the present invention is further described hereinafter with reference to the accompanying drawings and embodiments.

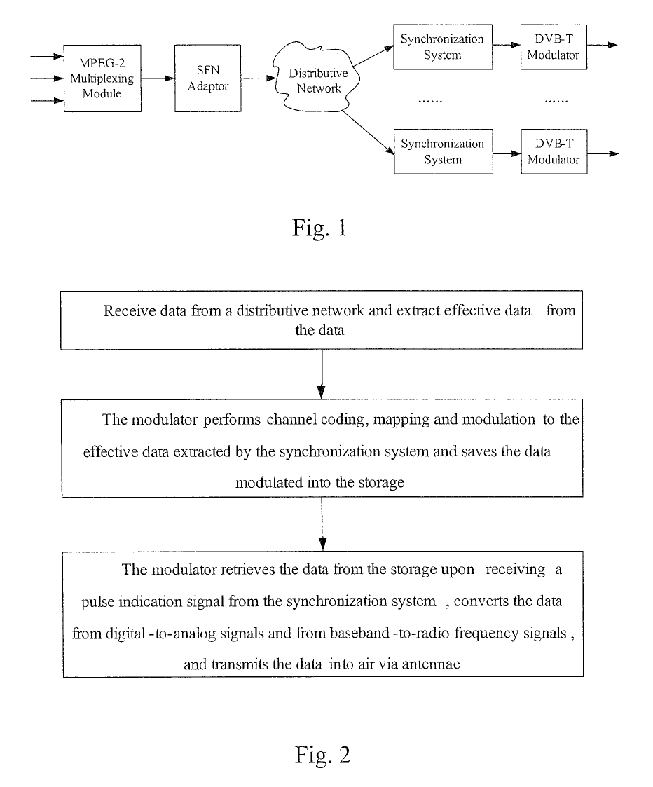

An embodiment of the present invention discloses a method for signal synchronization transmission in an SFN transmission system. The SFN transmission system includes a synchronization system and a modulator. With reference to FIG. 2, the method is as followings.

A) Data is received from a distributive network, effective data is extracted from the data; this step can but not limited to be done by the synchronization system.

B) Channel coding, mapping and modulation are performed by the modulator to the effective data extracted by the synchronization system; the modulated data is saved into storage.

C) When the modulator receives a pulse indication signal, the data is retrieved from the storage, converted by the digital-analog conversion and baseband-to-radio frequency conversion and transmitted into air via antennae.

In this embodiment, the storage in step B can but not limited to be arranged in the modulator as a component of the modulator.

Storage capacity in step B of this embodiment is proportional to the cycle of the pulse indication signals, i.e., the longer the cycle is the larger the capacity should be, because the storage need to save all data modulated between two retrieving actions. Storage with large capacity costs high, while short cycle of the pulse indication signals induces the saving and retrieving of the data too frequently. Therefore, a compromise between the capacity of the storage and the cycle of the pulse indication signals may be made in practical applications.

In an embodiment of the present invention, the method may but is not limited to further include a step A1 after step A. Step A1 includes that the effective data extracted by the synchronization system is saved into storage, when a pulse indication signal is received by the transmitter from the synchronization system, the effective data is retrieved and sent to the modulator.

In an embodiment, the storage described in step A1 and the storage described in step B may be a same storage or two different storages. If they are two different storages, the storage described in step A1 can but not limited to be arranged in the synchronization system as a component of the synchronization system; the storage described in step A1 can also be arranged in the modulator.

In an embodiment, the pulse indication signal described in step A1 and the pulse indication signal described in step B may be a same signal or different signals. If they are different signals, the two pulse indication signal may have the same cycle or have different cycles.

In practical applications, other steps may also be included in the method. For example, the channel coded data or mapped data can also be saved in storage and be retrieved for further processing upon receiving a pulse indication signal. The storage and the pulse indication signal can be the same storage and the pulse indication signal described in step A1 and step B, or be a different storage and pulse indication signal. When a different storage is used, the storage can but not limited to be arranged in the modulator.

In a conventional method for baseband transmission synchronization, different channel coding modules, mapping modules and modulation modules may be adopted in different transmitters and eventually provide different time consumption, and therefore different transmitters can not be guaranteed to transmit data at exactly the same time. In the method of radio frequency transmission according to the embodiment of the present invention, the time consumption of modules including the digital-to-analog conversions (DACs) and the baseband-to-radio frequency converters in different transmitters are almost the same, which means the antennae can synchronously transmit the data into air in the form of radio frequency signals. In the embodiment of the present invention, the radio frequency synchronization transmission equals synchronization transmission of the radio frequency antennae.

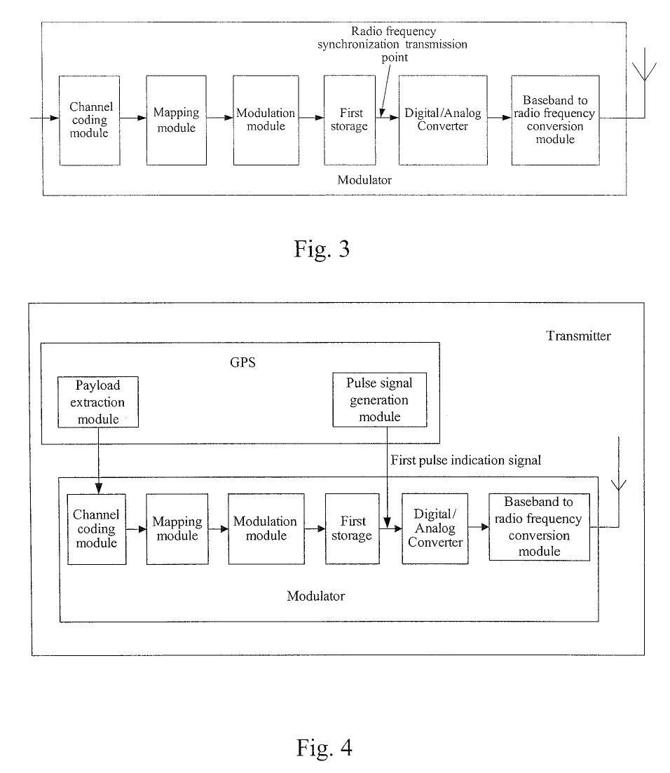

An embodiment of the present invention discloses a modulator in a transmitter in an SFN transmission system. With reference to FIG. 3, the modulator includes a channel coding module, a mapping module, a modulation module, a DAC, a baseband-to-radio frequency converter and storage.

The channel coding module in the embodiment is adapted to receive the effective data extracted by the synchronization system and perform channel coding to the effective data.

The mapping module in the embodiment is adapted to receive the data coded by the channel coding and to map the data.

The storage in the embodiment includes at least a first storage. The modulator in the embodiment is adapted to receive a pulse indication signal. The pulse indication signal may but not limited to be from the synchronization system and the pulse indication signal includes at least a first pulse indication signal.

The modulation module in the embodiment is adapted to modulate the mapped data and save the modulated data into the first storage.

Upon receiving the first pulse indication signal, the modulation module in the embodiment retrieves the data from the first storage and sends the data to the DAC. A processing point between the first storage and the DAC can be regarded as a radio frequency synchronization transmission point in the embodiment.

The DAC in the embodiment is adapted to perform digital-to-analog conversion to the data.

The baseband-to-radio frequency converter in the embodiment is adapted to receive the data processed through the digital-to-analog conversion and convert the data into radio frequency signals to be transmitted into air via the antennae.

The capacity of the first storage in the embodiment is proportional to the cycle of the first pulse indication signal. The longer the cycle is, the larger the capacity should be. In practical applications, a compromise can be made between the capacity of the first storage and the cycle of the first pulse indication signal.

The storage in the embodiment may further include a second storage adapted to save the effective data extracted by the synchronization system.

The pulse indication signal received by the modulator in the embodiment may further include a second pulse indication signal. The cycle of the second pulse indication signal may be identical to or different from that of the first pulse indication signal. The modulator is adapted to retrieve the data from the second storage upon receiving the first or the second pulse indication signal and to send the retrieved data to the channel coding module. A processing point between the second storage and the channel coding module in the embodiment can be regarded as a baseband synchronization transmission point.

In practical applications, if necessary, the channel coding module and/or the mapping module may save the data into storage after processing the data and the modulator retrieves the data upon receiving a pulse indication signal and sends the data to the module that should process the data in a next step.

An embodiment of the present invention also discloses a transmitter in an SFN transmission system. With reference to FIG. 4, the transmitter includes a synchronization system, a modulator and storage. The storage in the transmitter includes at least a first storage.

The synchronization system in the embodiment includes effective data extraction module and a pulse signal generation module. The effective data extraction module is adapted to receive data from the distributive network and extract the effective data. The pulse signal generation module is adapted to provide a pulse indication signal. The pulse indication signal includes at least a first pulse indication signal.

The modulator in the embodiment includes a channel coding module, a mapping module, a modulation module, a DAC and a baseband-to-radio frequency converter.

The channel coding module in the embodiment is adapted to receive the effective data extracted by the synchronization system and perform channel coding to the effective data;

The mapping module in the embodiment is adapted to receive the data coded by the channel coding and to map the data.

The modulation module in the embodiment is adapted to modulate the mapped data and save the modulated data into the first storage.

Upon receiving the first pulse indication signal from the pulse signal generation module, the modulation module in the embodiment retrieves the data from the first storage and sends the data to the DAC. In the embodiment, a processing point between the first storage and the DAC can be regarded as a radio frequency synchronization transmission point.

The DAC in the embodiment is adapted to perform digital-to-analog conversion to the data.

The baseband-to-radio frequency converter in the embodiment is adapted to receive the data processed through the digital-to-analog conversion and convert the data into radio frequency signals to be transmitted into air via antennae.

The first storage in the embodiment can but not limited to be a component of the modulator.

The capacity of the storage in the embodiment is proportional to the cycle of the pulse indication signal. The longer the cycle is, the larger the capacity of the storage should be. In practical applications, a compromise can be made between the capacity of the storage and the cycle of the pulse indication signal.

The storage in the embodiment may further include a second storage adapted to save the effective data extracted by the synchronization system.

The pulse indication signal from the pulse signal generation module in the embodiment may further include a second pulse indication signal. The cycle of the second pulse indication signal may be identical to or different from that of the first pulse indication signal. The modulator is adapted to retrieve the data from the second storage upon receiving the first or the second pulse indication signal and to send the retrieved data to the channel coding module. A processing point between the second storage and the channel coding module in the embodiment can be regarded as a baseband synchronization transmission point.

The first storage in the embodiment can but not limited to be arranged in the modulator as a component of the modulator; the second storage can but not limited to be arranged in the synchronization system as a component of the synchronization system.

In practical applications, if necessary, the channel coding module and/or the mapping module may save the data into storage after processing the data and the modulator retrieves the data upon receiving a pulse indication signal and sends the data to the module that should process the data in the next step.

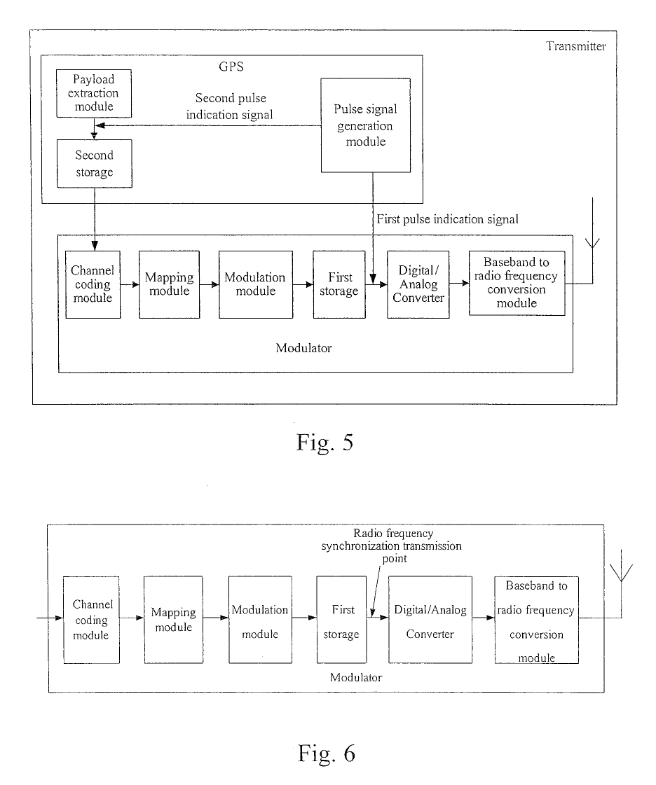

An embodiment of the invention discloses a transmitter in an SFN system. With reference to FIG. 5, the transmitter includes a GPS functioning as a synchronization system, a modulator and storage. In this embodiment, the storage includes a first storage and a second storage, which are arranged in the modulator and the GPS respectively.

The GPS in this embodiment includes an effective data extraction module, a pulse signal generation module and the second storage.

The effective data extraction module in the embodiment is adapted to receive data from a distributive network, extract the effective data of the data and save the effective data into the second storage.

The pulse signal generation module in the embodiment is adapted to provide a pulse indication signal; the pulse indication signal includes a first pulse indication signal and a second pulse indication signal; and first and the second pulse indication signals may have the same cycle or different cycles.

With reference to FIG. 6, the modulator in the embodiment includes a channel coding module, a mapping module, a modulation module, a DAC, a baseband-to-radio frequency converter and the first storage.

The transmitter is adapted to retrieve the data from the second storage upon receiving the second pulse indication signal and send the data to the channel coding module in the modulator. A processing point between the second storage and the channel coding module in the embodiment can be regarded as a baseband synchronization transmission point.

The channel coding module in the embodiment is adapted to receive the effective data extracted by the synchronization system and perform channel coding to the effective data.

The mapping module in the embodiment is adapted to receive the data coded by the channel coding and to map the data.

The modulation module in the embodiment is adapted to modulate the data mapped and save the data modulated into the first storage.

The modulator in the embodiment is adapted to retrieve the data from the first storage upon receiving the first pulse indication signal from the synchronization system module and send the data to the DAC. In the embodiment, a processing point between the first storage and the DAC is regarded as a radio frequency synchronization transmission point.

The DAC in the embodiment is adapted to perform digital-to-analog conversion to the data.

The baseband-to-radio frequency converter in the embodiment is adapted to receive the data processed through the digital-to-analog conversion and convert the data into radio frequency signals to be transmitted into air via the antennae.

The data transmission procedure performed by the transmitter includes:

a) Data is received from the distributive network by the synchronization system, and the effective data of the data is extracted and saved into the second storage;

b) Data is retrieved from the second storage by the transmitter upon receiving the second pulse indication signal and sent to the modulator;

c) Channel coding, mapping and modulation procedures are performed by the modulator to the effective data extracted by the synchronization system and the modulated data is saved into the first storage; and

d) The data is retrieved from the first storage by the modulator upon receiving the first pulse indication signal from the synchronization system module, and is converted from digital to analog signals and from baseband to radio frequency signals, and are transmitted into air via antennae.

The present invention may have a variety of embodiments and the skilled in the art may produce modifications and alterations of the present invention without departing from the scope of the present invention, hence all these modifications and alterations of the present invention shall be included in the scope defined by the claims.

What is claimed is:

1. A method for signal synchronization transmission in a single frequency network transmission system, comprising:
A) extracting effective data from data received;
B) performing channel coding, mapping and modulation to the effective data extracted and saving the data modulated into a storage; and
C) retrieving the data from the storage upon receiving a pulse indication signal, performing digital-to-analog conversion and baseband-to-radio frequency conversion to the data retrieved and transmitting the data converted into air via antennae.

2. The method of claim 1, further comprising: after step A,
A1) saving the effective data extracted into a storage, retrieving the effective data extracted from the storage upon receiving a pulse indication signal and performing step B.

3. The method of claim 2, further comprising: before step A, receiving the data from a distributive network.

4. The method of claim 2, wherein the storage described in step A1 and the storage described in step B are two storages independent of each other.

5. The method of claim 4, wherein the pulse indication signal described in step A1 and the pulse indication signal described in step B are a same pulse indication signal.

6. The method of claim 4, wherein the pulse indication signal described in step A1 and the pulse indication signal described in step B are two different pulse indication signals.

7. The method of claim 4, wherein the pulse indication signal described in step A1 and the pulse indication signal described in step B are two different pulse indication signals with the same cycle or different cycles.

8. The method of claim 2, wherein the pulse indication signal described in step A1 and the pulse indication signal described in step B are a same pulse indication signal.

9. The method of claim 2, wherein the pulse indication signal described in step A1 and the pulse indication signal described in step B are two different pulse indication signals with the same cycle or different cycles.

10. The method of claim 1, further comprising: before step A, receiving the data from a distributive network.

11. A modulator in a transmitter in a single frequency network, comprising:
a channel coding module, adapted to receive effective data extracted and performing channel coding;
a mapping module, adapted to receive the data coded by the channel coding and to map the data;
a modulation module, adapted to modulate the data mapped;
a digital-to-analog converter (DAC), adapted to convert the data modulated into analog signals; and
a baseband-to-radio frequency converter, adapted to convert the analog signals into radio frequency signals to be transmitted into air via antennae;
the transmitter further including:
storage, connected to the modulation module and adapted to save the data modulated, wherein
the modulator retrieves the data from the storage upon receiving a pulse indication signal and sends the data to the DAC.

12. The modulator of claim 11, wherein the pulse indication signal is received by the modulator from a synchronization system.

13. A transmitter in a single frequency network system, comprising a synchronization system and a modulator, wherein
the synchronization system comprises:
an effective data extraction module, adapted to receive data from the distributive network and extract effective data from the data; and
a pulse signal generation module, adapted to provide a pulse indication signal which comprises at least a first pulse indication signal;
the modulator comprises:
a channel coding module, adapted to receive the effective data extracted and performing channel coding;
a mapping module, adapted to receive the data coded by the channel coding and to map the data;
a modulation module, adapted to modulate the data mapped;
a digital-to-analog converter (DAC), adapted to convert the data modulated into analog signals; and
a baseband-to-radio frequency converter, adapted to convert the analog signals into radio frequency signals to be transmitted into air via antennae;
and the modulator further comprises a storage, which further comprises at least
a first storage, connected to the modulation module and adapted to save the data modulated, wherein
the modulator retrieves the data in the first storage upon receiving the first pulse indication signal and sends the data to the DAC.

14. The transmitter of claim 13, wherein the storage further comprises:
a second storage, connected to the effective data extraction module, and adapted to save the effective data extracted;
the pulse indication signals provided by the pulse signal generation module may further comprises a second pulse indication signal; the first and the second pulse indication signals have the same cycle or different cycles; and
the transmitter retrieves the data from the second storage upon receiving one or the first and the second pulse indication signal and sends the data to the channel coding module.

15. The transmitter of claim 14, wherein the first storage is arranged in the modulator.

16. The transmitter of claim 14, wherein the second storage is arranged in the synchronization system.

17. The transmitter of claim 13, wherein the first storage is arranged in the modulator.
